(19) United States
(12) Patent Application Publication
(10) Pub. No.: US 2024/0400111 A1
(43) Pub. Date: Dec. 5, 2024

(54) METHOD AND CONTROL CIRCUIT FOR CHECKING, IF A CURRENT ACTIVE DRIVING MODE IS OPERATED WITHIN ITS ODD, AND SYSTEM AND BACKEND SERVER

(71) Applicant: CARIAD SE, Wolfsburg (DE)

(72) Inventors: David Alexander Badouin, Ingolstadt (DE); Endre Aladar Papp, Ingolstadt (DE); Mohamed Essayed Bouzouraa, Ingolstadt (DE)

(21) Appl. No.: 18/689,049

(22) PCT Filed: Aug. 10, 2022
(86) PCT No.: PCT/EP2022/072444

§ 371 Date: Mar. 4, 2024

(30) Foreign Application Priority Data
Sep. 8, 2021 (DE) 10 2021 123 270.8

(51) Int. Cl. B60W 60/00; B60W 50/00; B60W 50/04; G06V 20/56

(52) U.S. Cl. CPC B60W 60/005; B60W 50/045; G06V 20/56; B60W 2050/0014

(57) ABSTRACT

The disclosure relates to a method for checking whether a presently active automated and/or assisted driving mode of a first vehicle, which travels along a travel route by way of the driving mode, is being operated within an operational design domain (ODD) boundary of an ODD of the driving mode, wherein a measurement of ODD features marking the ODD boundary is carried out in an environment of the first vehicle by way of at least one environment sensor. The measurement is carried out by way of at least one second vehicle driving ahead of the first vehicle on the travel route, and is carried out by a back-end server that couples the at least one second vehicle to the first vehicle via respective communication links, wherein measured ODD features are gathered, and/or an ODD monitoring routine is carried out.

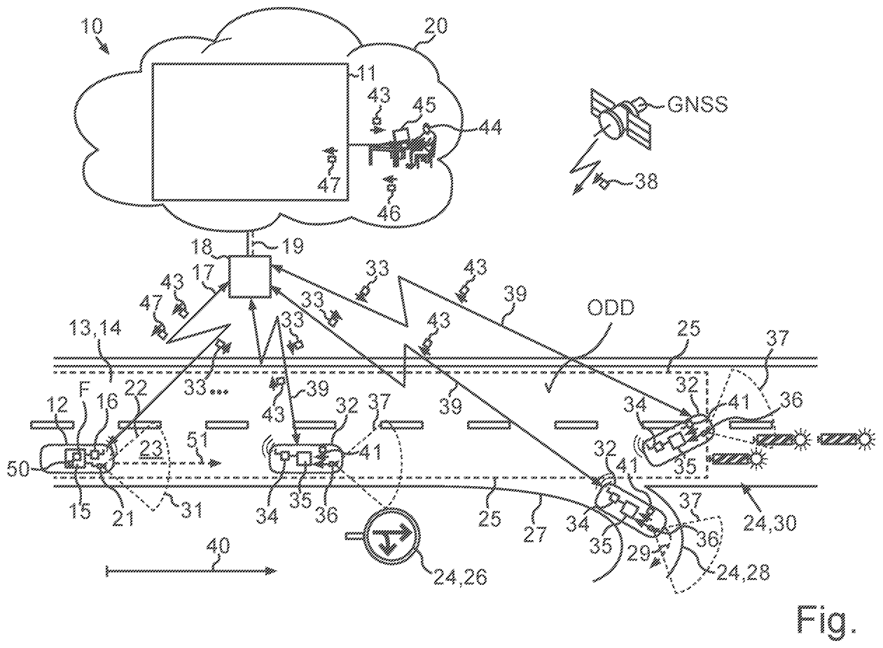

### BACKGROUND

### Technical Field

The disclosure relates to a method and a control circuit for checking whether a presently active automated and/or assisted driving mode of a vehicle, which travels along a travel route by way of the driving mode, is being operated within the ODD boundary of an operational design domain, ODD, of the driving mode. When the vehicle leaves the ODD, the driving mode must be disabled. The disclosure also includes a backend server and a system.

### Description of the Related Art

An operational design domain (ODD) is a specific operational domain or a group of operational domains, in which an automated driving function or an automated system should properly function, including, but not limited to road types, speed range, environmental conditions (e.g., weather, day/nighttime) and/or driving situations, delimited in each case by domain restrictions (ODD boundary). The ODD boundary is given by all such locations and/or driving situations, at which there is an ODD feature that prohibits the use of an automated and/or assisted driving mode. If, for example, the driving mode is not intended for the automated operation of the vehicle at a traffic light, then, accordingly, a traffic light represents an ODD feature marking the ODD boundary of the driving mode, i.e., when reaching or passing an ODD feature the driving mode should be deactivated, because the ODD boundary is reached.

Automated and/or assisted driving modes, in particular driving modes of HAF driving systems (HAF-highly automated driving mode, i.e., so-called automation level L3 or higher), must be able to identify their functional boundaries or challenging situations (together the ODD) independently. This can be achieved by environmental sensors but also based on cards.

Disadvantageously, identification, in particular in case of short-term changes of the ODD conditions, cannot be done sufficiently early in all cases. It may happen that the remaining path from identification to the ODD boundary being exceeded is not sufficient to:
a) transfer the driving task to the driver at level L3 and to give him the chance to react appropriately or
b) to ensure a suitable solution for the situation at level L4 by treating or striving for a qualified safe state.

DE 10 2013 210 395 B4 discloses that vehicles with automated driving modes identify reaching an ODD boundary based on sensors based and thereupon can deactivate the driving mode. A central backend server can be used to query all those locations, at which such a deactivation of the driving mode took place because of a detection of an ODD boundary. Then, a digital road map can be created, in which the ODD boundaries are recorded. Disadvantageously, this solution requires that the queried vehicles first have to drive up to the still unknown ODD boundary and, as a result, these vehicles may encounter the above described situation, that only little time remains to deactivate of driving mode.

EP 3 745 376 A1 discloses that map data can be generated by motor vehicles by surveying the environment in order to make this map data available to other motor vehicles, which can use it to operate their automated driving modes. However, this requires a corresponding amount of time to first detect enough map data of an environment before sufficient map data is available. In addition, such map data cannot be used to react to acute special cases, such as a traffic jam that has arisen.

US 2020/0241564 A1 discloses that a navigation system of a motor vehicle can configure route planning in such a way that the largest possible proportion of a travel route lies within an ODD of an autonomous driving mode, so that the trip can be carried out autonomously by the motor vehicle. However, if a spontaneous event occurs while driving, such as a traffic jam, the autonomous motor vehicle itself must identify that an ODD boundary may be reached.

DE 10 2021 001 096 A1 discloses the mapping of road objects in a digital road map that cannot be identified by sensors. Such unidentifiable road objects are interpreted as an ODD boundary for deactivating a driving mode. The problem here too is that the first vehicles that drive past these unidentifiable road objects cannot be warned.

US 2019/0184997 A1 discloses how a motor vehicle can switch off an automated driving mode if an ODD boundary is reached or the vehicle approaches the ODD boundary.

### BRIEF SUMMARY

The disclosure is based on the object of identifying the approach to an ODD boundary of the ODD of the driving mode in a timely or early manner in an active driving mode for automated and/or assisted driving in order to have enough time to deactivate the driving mode before the ODD boundary is reached.

As a solution, the disclosure comprises a method for checking whether a presently active automated and/or assisted driving mode of a vehicle, which travels along a travel route by way of this driving mode, is being operated within the ODD boundary of an operational design domain, ODD, of the driving mode, which ODD boundary is specified for the driving mode. A measurement of predefined ODD features marking the ODD boundary is carried out in surroundings or an environment of the vehicle by way of at least an environment sensor. That to say, there is an active search or sensing as to whether the ODD boundary can be identified based on ODD features. Based on the measured ODD features, a predefined boundary criterion is checked by way of an ODD monitoring routine, which boundary criterion indicates, if the vehicle approaches an ODD boundary and thus leaving the ODD is imminent. An ODD boundary can also result from the fact that predefined ODD attributes are missing, that is to say, such attributes that are expected to arise within the ODD are no longer or are not present. That is to say, the absence of ODD attributes can also be interpreted as an ODD feature for an ODD boundary.

An automated driving mode can provide that forward guidance and/or sideways guidance of the vehicle is carried out in an automated manner, that is, without the intervention of a driver, by a control circuit controlling an actuator of the vehicle for forward guidance and/or sideways guidance. An assisted driving mode, on the other hand, can offer a driver assistance and/or information when driving the vehicle, for example, providing assisted overtaking and/or parking. The boundary criterion for identifying the ODD boundary can be set by the person skilled in the art in such a way that all those ODD features that are relevant for the driving mode, for example, a traffic light and/or a traffic sign and/or a predefined arrangement of third-party vehicles in the surroundings, are identified by the ODD monitoring routine as an ODD boundary. For this purpose, the person skilled in the art can define appropriate descriptions in the ODD monitoring routine as required. The ODD monitoring routine can be carried out by a processor circuit. It can, for example, be configured as software for the processor circuit.

The solution according to the disclosure seeks to identify the ODD boundary as early as possible and/or at a distance from the vehicle in order to have enough time to deactivate the driving mode until the ODD boundary is reached.

For this purpose, it is provided that the measurement of the ODD features is carried out by way of at least one third-party vehicle driving ahead of the vehicle on the travel route and the measured feature data of the ODD features are collected by a backend server that couples the at least one third-party vehicle to the vehicle via respective communication links, and/or the ODD monitoring routine is carried out by said backend server. In other words, the vehicle uses at least one third-party vehicle in front to carry out the measurement of ODD features in the environment. This means that the measurement of ODD features is brought forward in accordance with the distance to the third-party vehicle in front. In order to reliably couple the at least one third-party vehicle to the vehicle, the communication, i.e., in particular the transmission of feature data of the measured ODD features, takes place via a backend server which maintains corresponding communication links which can be provided, for example, on at least one radio link and/or at least one internet link. For example, mobile communications technology and/or WIFI technology can be used. Generally, such communication is known as V2X communication (V2X-vehicle-to-X communication, where X stands for a communication device in a vehicle or a stationary infrastructure object of a road system). In other words, the method uses sensor inputs or measurement channels from at least one third-party vehicle in front in order to carry out the measurement of ODD features early or at a distance from the vehicle. For example, a traffic light can be detected by a third-party vehicle in front as an ODD feature and signaled to the backend server as an ODD feature. The backend server can be implemented, for example, as a computer or a computer network on the Internet. A third-party vehicle can be a motor vehicle that is different from the vehicle whose driving mode is monitored by the method, i.e., another road user, e.g., a passenger car or truck.

The disclosure has the advantage that ODD features for the vehicle that have arisen or appeared on short notice in the environment, such as, for example, a damaged traffic sign and/or a traffic light out of order and/or a traffic jam, can also be identified early or in advance. For this purpose, at least one third-party vehicle can be used, which may itself be driven by a person and therefore does not have to have an active driving mode. A third-party vehicle therefore only has to meet minimal technical requirements. The vehicle and the at least one other vehicle driving in front form a line of cars in the sense that these vehicles are preferably traveling at the same time or driving on the travel route.

The disclosure also comprises embodiments that provide additional advantages.

One embodiment comprises that at least some of the measured ODD features in each case are signaled as a recording of a sensor signal, in particular a video signal, and as metadata, in particular positional information about a position of the ODD feature and/or orientation information about a spatial orientation about the ODD feature. In other words, the third-party vehicle itself does not have to interpret whether an applicable or relevant ODD feature has actually been detected. The third-party vehicle only has to provide the sensor signal that detects or signals a possible ODD feature. In addition, the position of this measured ODD feature and/or its orientation can be signaled, for example, as an indication of a compass direction or a direction of travel or angle information regarding a reference angle. The orientation information determines, for example, in which direction the ODD feature points, so that, for example, the orientation of a traffic light and/or a traffic sign is signaled. If objects of a certain object type (for example traffic signs of a specified sign type, for example, hazard warnings) are to be detected by a third-party vehicle as ODD features, a corresponding trigger can be set in the third-party vehicle, which when an object is identified the object type of which is detected in the third-party vehicle, the sensor signal, for example of a camera, is recorded and signaled to the backend server as a measured ODD feature (including the metadata).

An object and its object type can be identified in a third-party vehicle in a manner known per se by way of a machine learning method (e.g., traffic sign identification by way of computer vision). In this way, object detection can be carried out in the external vehicle in a manner known per se, which detects, for example, on the basis of a model for machine learning, for example an artificial neural network, using at least one sensor signal. For example, the described video signal and/or a radar signal and/or a LIDAR signal can be used as a sensor signal. By way of object detection or object identification, such a signal section or signal area (for example image area) can be identified in a sensor signal, which presumably or with a specified minimum probability or minimum confidence contains an object of a known object class, for example traffic sign, traffic light, road marking, road user, to name a few examples. To generate measured ODD features, this model can include a downstream filter, for example, which sends or reports such identified objects, for example, to the backend server or the vehicle that are being searched for as an ODD feature.

One embodiment comprises that the vehicle sends ODD parameters, which describe the ODD boundaries that are applicable to the driving mode and/or establish the ODD features to be measured which are indicative of the ODD boundaries, are sent to the backend server and/or to the at least one third-party vehicle and the measurement and/or the ODD monitoring routine are configured by way of the ODD parameters. This limits the measurement and/or the monitoring routine to the ODD boundaries applicable to the driving mode. The vehicle can thus provide information about the ODD features and/or ODD boundaries to be measured. If the ODD parameters only signal an ODD boundary (instead of the associated ODD features), a list of associated ODD features can be provided for each ODD boundary, for example in the backend server or in the respective third-party vehicle. For example, a list can be provided which assigns ODD features associated with an ODD boundary. For example, if a freeway is specified as the ODD (driving mode can only be operated on the freeway), then the ODD boundary is exits and parking lots and gas stations. Corresponding ODD features, for example, exit signs, exits with a corresponding road curvature, traffic signs of a specified color, can then be detected as ODD features that mark this ODD boundary. The ODD monitoring routine can, for example, determine which travel route ahead is planned for the vehicle and then identify whether the planned travel route will intersect the ODD boundary determined based on the ODD features, i.e., whether the ODD is likely to be left. A transfer measure can then be triggered to deactivate the driving mode. Route data of the travel route can be received, for example, from a navigation system of the motor vehicle and/or a navigation function of the backend server that supports the motor vehicle in navigation. The travel route can also be estimated, for example, based on historical travel routes, by selecting a travel route that has been traveled repeatedly as an estimated travel route.

One embodiment comprises that, in the event, that the third-party vehicle identifies an ODD feature and the third-party vehicle is driven by a person in a manual driving mode, a guidance profile of forward guidance and/or sideways guidance carried out by the person when approaching and/or passing the ODD feature is detected as a guide profile, and the guide profile is specified to the driving mode as a guide profile to be replicated by the driving mode in the vehicle. Thus, the driving behavior of an unknown person in the third-party vehicle can therefore be used to determine control signals for the vehicle that specify suitable behavior of the vehicle at the ODD boundary. As a result, the driving mode can be updated or expanded by replicating the guidance profile so that it can continue to be operated even at the ODD boundary, i.e., the ODD is dynamically expanded if a suitable guidance profile of a person could or was recorded.

One embodiment comprises that a vehicle-specific map of the environment of the ODD for the driving mode of the vehicle is generated by the backend server based on the collected ODD features and based on the boundary criterion, and is provided to the vehicle for future route planning. For example, software can be operated in the backend server which checks the measured ODD features to see whether they are applicable or correct ODD features that indeed mark the ODD boundary. In this way, incorrect detections or false detections can be compensated for. The respective position of the collected ODD features can then be used to detect or identify where the ODD boundary lies. This can then be mapped in the map of the environment so that the driving mode or driving function or route planning in the vehicle can take the ODD or the course of the ODD boundary into account when planning a route or trajectory. In this way, the presumed ODD boundary determined based on the collected ODD features is checked. This can support the early deactivation of the driving mode and/or result in a driving recommendation to be able to operate the driving mode on long travel routes when reaching a specified destination.

One embodiment comprises that the measured ODD features are outputted to an operator by the backend server via an operator interface and a user input of the operator is received and, depending on the user input, it is specified if the ODD feature meets the boundary criterion. The interpretation or identification or evaluation of a measured ODD feature can thus be carried out by an operator in the backend server. This has the advantage that ODD features can also be checked where automated evaluation fails due to, for example, the signal quality of the sensor signal and/or the appearance of the ODD feature, for example dirt on a traffic sign. The presentation of the ODD feature to the operator can be done “in the loop” or in real time, so that a third-party vehicle in front signals the measured ODD feature to the backend server, where the measured ODD feature is presented to the operator (if, for example, an automated evaluation signals an error or an identification confidence is lower than a threshold value) and then when a permissible ODD feature is detected that meets the boundary criterion or indicates the ODD boundary, this finding is signaled to the vehicle. Thus, human plausibility checks can be integrated into the processing chain for processing measured ODD features to check the boundary criterion. The user input can be a binary indication, for example, that the feature is to be ignored or not.

One embodiment comprises that in the event that the limit criterion is not met by a measured ODD feature, masking data signaling that this ODD feature is to be ignored is generated and sent to the vehicle and an ODD monitoring routine of the vehicle is configured by way of the masking data so that, upon detection of the ODD feature, said OTT feature is ignored by the ODD monitoring routine of the vehicle. If, in case of a measured ODD feature it is identified or detected that it does not meet the limit criterion, i.e., does not represent a marking of the ODD boundary, the masking data can be used to prevent the vehicle from misinterpreting the ODD feature by way of its own object detection. If an ODD feature is signaled by the third-party vehicle, then at least once an object detection has already incorrectly identified an ODD feature, even though it then turns out based on the boundary criterion that it does not mark an ODD boundary. This can be the case, for example, if a traffic light is shown on an advertising poster and traffic lights are searched for as ODD features. If, for example, the operator already described specifies based on the user input that the traffic light on the advertising poster is not an applicable ODD feature, then, this information can be communicated to the vehicle through the masking data so that its own object detection for identifying ODD features is not also deceived or generates false output signals that erroneously signal an applicable ODD feature when the vehicle itself reaches or passes the ODD feature.

One embodiment comprises that the third-party vehicle carries out the measurement of the ODD features when its own driving mode is missing or when its own driving mode is deactivated and/or activated. In other words, it is not necessary for the respective third-party vehicle itself to have the driving mode. It is sufficient if the third-party vehicle detects sensor signals, for example, video signals from a camera, and then checks whether a sought ODD feature, for example, a traffic sign or a traffic light, is identified. If the third-party vehicle has the driving mode itself, said driving mode does not have to be active. This means that third-party vehicles can also be used by way of the method that did not have to deactivate their driving mode at an ODD boundary that was only identifiable for a short time, for example.

One embodiment comprises that, in the vehicle, when approaching an ODD boundary and when leaving the ODD is imminent, a predefined transfer measure for deactivating the driving mode and transferring the forward guidance and/or sideways guidance of the vehicle to a driver is carried out. The vehicle can therefore deactivate the driving mode by transferring to a driver while driving or by driving the vehicle, for example, to a parking lot before reaching the ODD boundary and interrupting the trip there. Generally, a transfer measure can be used, as is known for automated driving modes in the prior art.

As a further solution, the disclosure comprises a control circuit for a vehicle. The control circuit is configured to provide an automated and/or assisted driving mode for the vehicle and to send ODD parameters which describe ODD boundaries of an ODD of the driving mode applicable to the driving mode and/or ODD features to be measured which mark the ODD boundaries, to a backend server and/or to at least one third-party vehicle and, from the backend server and/or the at least one third-party vehicle, to receive measured ODD features and/or map data of ODD boundaries of the ODD estimated from measured ODD features and thus to limit an operation of the driving mode to the ODD applicable to the driving mode (when an approach to an ODD boundary is identified). This can be done by way of the ODD monitoring routine. The vehicle is preferably designed as a motor vehicle, in particular as a passenger car or truck, or as a passenger bus or motorcycle. The control circuit can be designed, for example, as a control device or a network of control devices for a vehicle.

The control circuit can have a data processing device or a processor unit that is configured to carry out the method steps described. The control circuit can have at least one microprocessor and/or at least one microcontroller and/or at least one FPGA (Field Programmable Gate Array) and/or at least one DSP (Digital Signal Processor). Furthermore, the control circuit can have program code that is configured to carry out the method steps when executed by the processor device. The program code can be stored in a data memory of the control circuit.

As a further solution, the disclosure comprises a backend server for a vehicle with an automated and/or assisted driving mode. The backend server is configured to receive ODD parameters which describe ODD boundaries of an ODD of the driving mode applicable for the driving mode and/or ODD features to be measured which mark the ODD boundaries, from the vehicle via a communication link, to activate at least one third-party vehicle driving ahead of the vehicle for measuring the ODD features via a respective communication link and to send the measured ODD features and/or map data of ODD boundaries of the ODD estimated from measured ODD features to the vehicle. In the manner described, the backend server can comprise a computer or a network of several computers. The backend server can be operated as an Internet server. The respective communication link to a third-party vehicle or the vehicle can be implemented in the manner described, radio-based and/or based on an Internet link. The ODD parameters can then specify which ODD features or which ODD boundary (e.g., the edge of a freeway area) to search for. Corresponding detection commands or measurement commands for at least one ODD feature can then be sent to at least one third-party vehicle, which can then signal ODD features measured as measurement results. Whether a third-party vehicle is on a section of the route ahead of the vehicle, i.e., whether a third-party vehicle represents a vehicle in front, can be determined based on travel route data and/or a geo position and a direction of travel of the third-party vehicle.

As a further solution, the disclosure includes a system comprising an embodiment of the backend server according to the disclosure and at least one vehicle with an embodiment of the control circuit according to the disclosure. The system therefore comprises the interaction of a backend server and at least one vehicle in order to carry out an embodiment of the method according to the disclosure.

The disclosure also comprises the combinations of the features of the described embodiments. The disclosure therefore also comprises implementations that each have a combination of the features of several of the described embodiments, provided that the embodiments have not been described as mutually exclusive.

### BRIEF DESCRIPTION OF THE SEVERAL VIEWS OF THE DRAWINGS

Examples of embodiments of the disclosure are described below.

The FIGURE shows a schematic representation of an embodiment of the system according to the disclosure, which can carry out an embodiment of the method according to the disclosure.

### DETAILED DESCRIPTION

The exemplary embodiments explained below are advantageous embodiments of the disclosure. In the exemplary embodiments, the described components of the embodiments each represent individual features of the disclosure that are to be considered independently of one another and which also refine the disclosure independently of one another. Therefore, the disclosure is intended to comprise combinations of the features of the embodiments other than those shown. Furthermore, the described embodiments can also be supplemented by further features of the disclosure that have already been described.

In the FIGURE, same reference numerals designate functionally identical elements.

The FIGURE shows a system 10 with a backend server 11 and a vehicle 12, which can be designed as a motor vehicle, in particular as a passenger car or truck. Vehicle 12 may be operated on a road 13, which in the present example may be a freeway 14. Vehicle 12 can be operated in an automated driving mode F by way of a control circuit 15, for example an HAF or highly automated driving mode. A corresponding driving function can be implemented, for example, by an autopilot. Driving mode F can be limited to predefined driving situations, which results in an ODD for the driving mode F, within which the driving mode F may only be active. For example, it can be specified as ODD that driving mode F is only permissible in the area of freeway 14 as long as there are predefined driving conditions on freeway 14, for example there is no construction site.

Backend server 11 can be connected to a communication unit 16 of the vehicle 12 via a communication link 17, which can be routed, for example, as a radio link through a mobile radio network 18 and can lead to internet 20 via an internet link 19, in which backend server 11 can be operated. For this purpose, corresponding communication links 39 to respective third-party vehicle 32 can be operated from backend server 11 via its communication unit 34. A communication unit 16 can be implemented, for example, on the basis of a mobile radio module and/or WIFI module.

In order to ensure that driving mode F, while it is in operation, is also operated within the ODD, at least one sensor 21 can be operated in vehicle 12 in a manner known per se, the detection area 22 of which can be aligned with an environment 23 of the vehicle 12. By way of at least one sensor 21, control circuit 15 can be used determine whether an ODD feature 24 is present, which signals that an ODD boundary 25 of the ODD has been reached or is present, within which driving mode F can only be active. In the FIGURE, exemplary ODD boundaries are a traffic sign 26, which signals that there is an exit 27 that leads away from freeway 14. Another possible ODD feature 24 can be a curve 28 whose curve radius 29 is smaller than a limit value permissible for driving mode F. Another ODD feature 24 may be a construction site 30, which may have been established on freeway 14 and thus prohibits the operation or the activity of driving mode F in the area of the construction site.

Since respective sensor 21 has a detection range 22 limited to a maximum range 31, an ODD feature 24 can only be detected within the maximum range for vehicle 12 by way of respective sensor 21, which possibly may lead to a short-term termination or deactivation of driving mode F. This is avoided in vehicle 12 by system 10. For this purpose, in system 10, at least one third-party vehicle 32 is used by way of backend server 11 to detect ODD features 24 that indicate or mark ODD boundary 25. Control circuit 15 can be used to transmit ODD parameters 33 to backend server 11 via communication unit 16. Backend server 11 can send ODD parameters 33 or measurement commands or detection commands derived therefrom to third-party vehicles 32. In every third-party vehicle a communication unit 34, a control device 35 and at least one sensor 36 with a detection area 37 aligned with environment 23 can be provided, made available or used. Using ODD parameters 33, control unit 35 can also be used to detect or measure ODD features 24 in each third-party vehicle 32. Third-party vehicles 32 are preferably selected by backend server 11 whose position and/or travel route indicates that they are third-party vehicles driving in front of vehicle 12. For this purpose, for example, a global navigation satellite system GNS, for example the GPS (Global Positioning System), can utilize a position signal 38, which can be used in the vehicle 12 and the respective third-party vehicle 32 to be received by way of a receiver for position signal 38 and thus to determine the position of respective vehicle 12 and respective third-party vehicle 32 and, for example, to signal it to backend server 11 via communication link 17, 39.

Because third-party vehicles 32 driving in front are involved, corresponding sensor 36 is also arranged in front of vehicle 12 in the direction of travel and thus beyond maximum range 31 of sensor 21 of vehicle 12. This means a gain in time and/or distance in the sense that an ODD feature 24 can already be received at a distance ahead 40 by a third-party vehicle 32, even before an ODD feature 24 can be identified by way of at least one sensor 21 of vehicle 12 itself. Accordingly, there is time to deactivate driving mode F when approaching ODD boundary 25 marked by ODD feature 24. In respective control device 35, for example, an object detection can be operated, through which it can be determined based on a sensor signal of respective sensor signal 41 of respective sensor 36 which objects have been identified or detected in sensor signal 41 from environment 23. If one of these detected objects falls into an identification scheme or identification pattern corresponding to the ODD feature sought, as may be specified by ODD parameters 33, a measured ODD feature 43 can be signaled to backend server 11 from respective third-party vehicle 32, i.e., feature data of a measurement result are signaled. Provision can be made in backend server 11 to display measured ODD data of measured ODD features 43 to an operator 44 via a user interface 45, for example, a screen, and to receive a user input 46 from operator 44, which can, for example, confirm that it is an applicable or valid ODD feature for ODD boundary 25 or, conversely, if the ODD feature is rejected, masking data 47 can be generated, which indicates that an object detection may identify a potential or possible ODD feature 24, but that this is a deception or false detection because, for example, it can merely be an image of an ODD feature on an advertising poster, for example. Accordingly, confirmed ODD features 43 and/or the masking data 47 can be sent to the vehicle 12 via the communication link 17. In control circuit 15, for example, an ODD monitoring routine 50 can check whether a planned travel trajectory 51 will intersect ODD boundary 25, which is ahead of vehicle 12 based on ODD features 43. If this is the case, driving mode F can be deactivated and, for this purpose, a transfer measure can be triggered in a manner known per se, for example the driver of vehicle 12 can be asked to carry out the so-called driving task, that is to say the forward guidance and/or sideways guidance, which was previously carried out by activated driving mode F. Since this is done with the distance ahead 40, there is more time to carry out the transfer measure than in the case where the ODD features 24 would have been detected only by way of the at least one sensor 21 of vehicle 12 itself. The distance ahead 40 is larger than maximum range 31 of the at least one sensor 21.

Preferably, vehicles in front with comparable properties to the HAF system are used to measure the ODD according to the subsequent HAF system, i.e., vehicles that also have the driving mode. All vehicles suitable for measurement are provided with the necessary information about the ODD boundaries to be measured. This can be done, for example, via a radio link from a central backend.

While driving, the sensor inputs are checked for relevant ODD features. Assuming traffic lights represent an ODD boundary, a vehicle that detects a traffic light would record a video recording of the boundary with metadata such as position, etc., and transmit it to the backend. In the case of a manual drive, information about the human driver's handling (e.g., stopping at traffic lights) can be added to the information.

Information about the presumed ODD boundary can be stored on the server and a recommendation for handling each HAF system can be added. Human plausibility checks are then also conceivable.

A digital map with this information can be used in an HAF system and used there to better deal with (potential) ODD boundaries (early deactivation or conscious ignoring).

The (bidirectional) exchange of ODD information can be provided. The receiving vehicle sends information about its specific ODD boundaries to the backend, which creates a vehicle-specific ODD map for the vehicle by appropriately coupling the input data from data-collecting vehicles.

The detection range for ODD features is increased, thereby improving the system response to ODD boundaries.

Overall, the examples show how predictive identification of ODD boundaries (ODD-operational design domain) can be provided.

German patent application no. 102021123270.8, filed Sep. 8, 2021, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for checking whether a presently active automated and/or assisted driving mode of a first vehicle that travels along a travel route by way of the driving mode is being operated within an operational design domain (ODD) boundary of an ODD of the driving mode, wherein the ODD boundary is specified for the driving mode, the method comprising:
measuring ODD features marking the ODD boundary in an environment of the first vehicle by way of at least one environment sensor;
checking, based on the ODD features, a boundary criterion by way of an ODD monitoring routine, wherein the boundary criterion indicates if the first vehicle approaches the ODD boundary and leaving the ODD is imminent,
wherein the measuring is performed by at least one second vehicle traveling ahead of the first vehicle on the travel route and the ODD features are collected and/or the ODD monitoring routine performed by a backend server that couples the at least one second vehicle with the first vehicle via respective communication links.

2. The method according to claim 1, where at least some the ODD features are signaled as a recording of a sensor signal and as metadata.

3. The method according to claim 1, further comprising:
sending, by the first vehicle, ODD parameters that describe the ODD boundaries that are applicable to the driving mode and/or establish the ODD features to be measured that are indicative of the ODD boundaries to the backend server and/or to the second vehicle; and
limiting the ODD boundaries applicable to the driving mode by configuring the measuring and/or the ODD monitoring routine way of the ODD parameters.

4. The method according to claim 1, further comprising:
if the at least one second vehicle identifies one of the ODD features and the at least one second vehicle is driven by a person in a manual driving mode, detecting forward guidance and/or sideways guidance carried out by the person when approaching and/or passing the one of the ODD features as a guidance profile; and
specifying that the guidance profile is to be replicated by the driving mode in the first vehicle.

5. The method according to claim 1, further comprising:
generating, by the backend server, based on the ODD features and the boundary criterion, a vehicle-specific map of the environment of the ODD of the driving mode of the first vehicle; and
providing, by the backend server, the vehicle-specific map of the environment of the ODD of the driving mode of the first vehicle to the first vehicle for future route planning.

6. The method according to claim 1, further comprising:
outputting, by the backend server, one of the ODD features to an operator via an operating interface;
receiving, by the backend server, a user input of the operator; and
specifying, based on the user input, if the one of the ODD features meets the boundary criterion.

7. The method according to claim 1, further comprising:
if one of the ODD features does not meet the boundary criterion, generating masking data signaling that the one of the ODD feature is to be ignored;
sending the masking data to the first vehicle; and
configuring the ODD monitoring routine of the first vehicle by way of the masking data, so that, upon detection of the one of the ODD features, the one of the ODD features is ignored by the ODD monitoring routine of the vehicle.

8. The method according to claim 1, wherein the at least one second vehicle performs the measuring of the ODD features when a driving mode of the at least one second vehicle is missing or when a driving mode of the at least one second vehicle is deactivated and/or activated.

9. The method according to claim 1, further comprising:
when the first vehicle approaches the ODD boundary and leaving the ODD is imminent, performing a transfer measure that deactivates the driving mode and transfers forward guidance and/or sideways guidance of first vehicle to a driver of the first vehicle.

10. A control circuit for a first vehicle, the control circuit comprising:
at least one processor; and
at least one memory storing program code that, when executed by the at least one processor, causes the control circuit to:
provide an automated and/or assisted driving mode for the first vehicle;
send operational design domain (ODD) parameters that describe ODD boundaries of an ODD of the driving mode applicable to the driving mode and/or ODD features to be measured that mark the ODD boundaries, to a backend server and/or to at least one second vehicle;
receive, from the backend server and/or the at least one second vehicle, measured ODD features and/or map data of the ODD boundaries of the ODD estimated from the measured ODD features; and
limit an operation of the driving mode to the ODD applicable to the driving mode by triggering a transfer measure upon identifying an approach to one of the ODD boundaries.

11. A backend server for a first vehicle with an automated and/or assisted driving mode, the backend server comprising:
at least one processor; and
at least one memory storing program code that, when executed by the at least one processor, causes the backend server to:
receive operational design domain (ODD) parameters that describe ODD boundaries of an ODD of the driving mode applicable for the driving mode and/or ODD features to be measured which mark the ODD boundaries, from the first vehicle via a first communication link;
instruct at least one second vehicle driving ahead of the first vehicle to measure the ODD features via at least one second communication link; and
send the ODD features measured by the at least one second vehicle and/or map data of ODD boundaries of the ODD estimated from the ODD features measured by the at least one second vehicle to the first vehicle.

12. (canceled)

13. The method according to claim 2, where the recording of the sensor signal includes a video signal, and the metadata includes information about a position of one of the ODD features and/or orientation information about a spatial orientation of the one of the ODD features.
